(19) United States
(12) Patent Application Publication
(10) Pub. No.: US 2022/0095547 A1
(43) Pub. Date: Mar. 31, 2022

(54) METHOD FOR CONTROLLING A CONDITION OF A PLANT

(71) Applicant: MERCK PATENT GMBH, DARMSTADT (DE)

(72) Inventors: Hiroshi OKURA, Kanagawa (JP); Ryota YAMANASHI, Ebina (JP); Stephan DERTINGER, Heidelberg (DE); Werner STOCKUM, Reinheim (DE); Michael SCHABERGER, Griesheim (DE); Nina SIRAGUSA, Frankfurt Am Main (DE); Ryuta SUZUKI, Iwaki (JP); Kazuhisa AZUMA, Fukushima (JP); Takashi KUNIMOTO, Takamatsu (JP)

(73) Assignee: MERCK PATENT GMBH, DARMSTADT (DE)

(21) Appl. No.: 17/426,501

(22) PCT Filed: Jan. 27, 2020
(86) PCT No.: PCT/EP2020/051841

§ 371 Date: Jul. 28, 2021

(30) Foreign Application Priority Data
Jan. 29, 2019 (EP) 19154266.1
Aug. 29, 2019 (EP) 19194397.6

(51) Int. Cl. A01G 7/04; C09K 11/02; C09K 11/77; C09K 11/68; C09K 11/67; F21V 9/32

(52) U.S. Cl. CPC A01G 7/045; C09K 11/02; F21V 9/32; C09K 11/685; C09K 11/673; C09K 11/7703

(57) ABSTRACT

The present invention relates to a method for controlling a condition of a plant.

### FIELD OF THE INVENTION

The present invention relates to a method for controlling a condition of a plant, use of a phosphor, composition, a formulation, an optical medium, an optical device to control a condition of a plant, and a plant obtained from the method.

### BACKGROUND OF THE INVENTION

The plant growth is dependent on efficiency of light, temperature, nutrients, water and so on. By putting the nutrients on the leaf, it is especially possible to control the plant growth in the prior arts, for example, as described in WO2012/130924 A1 and WO 2009/055044 A1.

Moreover, a color conversion medium including a plurality of fluorescent materials, a light emitting diode device comprising a fluorescent material and optical devices comprising a light conversion medium for agriculture are known in the prior arts, for example, as described in JP 2007-135583A and WO 1993/009664 A1.

In addition, WO2017/129351 A1 discloses a light converting film containing a phosphor for controlling of plant growth.

WO2019/020653 A1 mentions spray coating of a phosphor composition especially on a leaf surface of a plant to control the light wavelength from a light source for controlling plant growth.

WO2019/020602 A2 mentions an optical medium comprising a phosphor composition and use of it for controlling plant growth.

### PATENT LITERATURE

1. WO 2012/130924 A1
2. WO 2009/055044 A1
3. WO 2017/129351 A1
4. WO 1993/009664 A1
5. WO 2019/020653 A1
6. WO 2019/020602 A2

### SUMMARY OF THE INVENTION

However, the inventors newly have found that there is still one or more of considerable problems for which improvement is desired, as listed below; in the case of the materials set on the leaf surface (front side), depending on the particle size of the material and the dispersion on the leaves, the influence of back scattering may become large, therefore the irradiation amount from the light source to the leaf surface inside is decreased.

Another objective of the present invention is to use of light emitted from the light source more efficiently.

Another objective of the present invention is preventing or reducing damping of the converted light emitted/reflected from the light converting material.

Another objective of the present invention is to provide a new optimal structure for acquiring the functional wavelengths for plants more efficiently and/or more easily.

Another objective of the present invention is to provide highly practical plant growing materials and installation methods for generating light with enhanced blue, red and/or infrared light color components.

Another objective of the present invention is to provide the materials' optical function to the plants for a longer time.

Another objective of the present invention is to provide a light modulating material, composition and/or a light converting medium for agriculture without requiring hard labor.

Another objective of the present invention is to provide a light modulating material, composition and/or a light converting medium for agriculture without paying high material costs.

Another objective of the present invention is to provide a light modulating material, composition and/or a light converting medium for agriculture capable of having two or more effects.

The inventors aimed to solve one or more of the above-mentioned problems.

Then it was found a new method for controlling a condition of a plant comprising, essentially consisting of, or consisting of following steps i) and ii);
i) absorbing at least a part of light that passed through a leaf of a plant with at least one light modulating material, a composition comprising at least one light modulating material and/or a light converting medium comprising at least one light modulating material,
wherein said at least one light modulating material, a composition comprising at least one light modulating material and/or a light converting medium comprising at least one light modulating material, is placed at least a part of the underside of a leaf;
ii) irradiating at least a part of the underside surface of a leaf of a plant with light emitted and/or with light selectively reflected from the light modulating material.

The present invention also relates to a plant obtained or obtainable from the method of the present invention.

The present invention further relates to a light converting medium comprising, essentially consisting of, or consisting of, at least one light modulating material and/or a composition of the present invention, and a matrix material, wherein the light converting medium contains at least one attaching part so that the light converting medium can be attached to a part of a plant.

The present invention further relates to use of the optical medium of the present invention to irradiate at least a part of underside of a leaf of a plant, preferably whole part of underside of a leaf of a plant.

### DEFINITION OF THE TERMS

The above outlines and the following details are for describing the present invention and are not for limiting the claimed invention. Unless otherwise stated, the following terms used in the specification and claims shall have the following meanings for this Application.

In this application, the use of the singular includes the plural, and the words “a”, “an” and “the” mean “at least one”, unless specifically stated otherwise. In this specification, when one concept component can be exhibited by plural species, and when its amount (e.g. weight %, mol %) is described, the amount means the total amount of them, unless specifically stated otherwise.

Furthermore, the use of the term “including”, as well as other forms such as “includes” and “included”, is not limiting. Also, terms such as “element” or “component” encompass both elements or components comprising one unit and elements or components that comprise more than one unit, unless specifically stated otherwise. As used herein, the term “and/or” refers to any combination of the elements including using a single element.

In the present specification, when the numerical range is shown using “to”, “-” or “˜”, the numerical range includes both numbers before and after the “to”, “-” or “˜”, and the unit is common for the both numbers, unless otherwise specified. For example, 5 to 25 mol % means 5 mol % or more and 25 mol % or less.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. If one or more of the incorporated literatures and similar materials defines a term in a manner that contradicts the definition of that term in this application, this application controls.

According to the present invention, the term “plant” means a multicellular organism in the kingdom Plantae that use photosynthesis to make their own food. Then according to the present invention, the plant can be flowers, vegetables, fruits, grasses, trees and horticultural crops (preferably flowers and horticultural crops, more preferably flowers). As one embodiment of the invention, the plant can be foliage plants. Exemplified embodiments of grasses are a poaceae, bambuseae (preferably sasa, phyllostachys), oryzeae (preferably oryza), pooideae (preferably poeae), triticeae (preferably elymus), elytrigia, hordeum, triticum, secale, arundineae, centotheceae, chloridoideae, hordeum vulgare, avena sativa, secale cereal, andropogoneae (preferably coix), cymbopogon, saccharum, sorghum, zea (preferably zea mays), sorghum bicolor, saccharum officinarum, coix lacryma-jobi var., paniceae (preferably panicum), setaria, echinochloa (preferably panicum miliaceum), echinochloa esculenta, and setaria italic. Embodiments of vegetables are stem vegetables, leaves vegetables, flowers vegetables, stalk vegetables, bulb vegetables, seed vegetables (preferably beans), roots vegetables, tubers vegetables, and fruits vegetables. One embodiment of the plant can be Gaillardia, Lettuce, Rucola, Komatsuna (Japanese mustard spinach) or Radish (preferably Gaillardia, Lettuce, or Rucola).

The term “light modulating material” is a material which can change at least one of physical properties of light. Preferably it is selected from pigments, dyes and luminescent materials.

The term “pigments” stands for materials that are insoluble in an aqueous solution and changes the color of reflected or transmitted light as the result of wavelength-selective absorption and/or reflection, e.g. Inorganic pigments, organic pigments and inorganic-organic hybrid pigments.

The term “dyes” means colored substances that are soluble in an aqueous solution and changes the color as the result of wavelength-selective absorption of irradiation.

The term “luminescent” means spontaneous emission of light by a substance not resulting from heat. It is intended to include both, phosphorescent light emission as well as fluorescent light emission.

Thus, the term “light luminescent material” is a material which can emit either fluorescent light or phosphorescent light.

The term “phosphorescent light emission” is defined as being a spin prohibition light emission from a triplet state or higher spin state (e.g. quintet) of spin multiplicity (2S+1)≥3, wherein S is the total spin angular momentum (sum of all the electron spins).

The term “fluorescent light emission” is a spin allowed light emission from a singlet state of spin multiplicity (2S+1)=1.

The term “wavelength converting material” or briefly referred to as a “converter” means a material that converts light of a first wavelength to light of a second wavelength, wherein the second wavelength is different from the first wavelength. Wavelength converting materials include organic materials and inorganic materials that can achieve photon up-conversion, and organic materials and inorganic materials that can achieve photon down-conversion.

The term “photon down-conversion” is a process which leads to the emission of light at longer wavelength than the excitation wavelength, e.g. by the absorption of one photon leads to the emission of light at longer wavelength.

The term “photon up-conversion” is a process that leads to the emission of light at shorter wavelength than the excitation wavelength, e.g. by the two-photon absorption (TPA) or Triplet-triplet annihilation (TTA), wherein the mechanisms for photon up-conversion are well known in the art.

The term “organic material” means a material of organometallic compounds and organic compounds without any metals or metal ions.

The term “organometallic compounds” stands for chemical compounds containing at least one chemical bond between a carbon atom of an organic molecule and a metal, including alkaline, alkaline earth, and transition metals, e.g. Alq₃, LiQ, Ir(ppy)₃.

The inorganic materials include phosphors and semiconductor nanoparticles.

A “phosphor” is a fluorescent or a phosphorescent inorganic material which contains one or more light emitting centers. The light emitting centers are formed by activator elements such as e.g. atoms or ions of rare earth metal elements, for example La, Ce, Pr, Nd, Pm, Sm, Eu, Gd, Tb, Dy, Ho, Er, Tm, Yb and Lu, and/or atoms or ions of transition metal elements, for example Cr, Mn, Fe, Co, Ni, Cu, Ag, Au and Zn, and/or atoms or ions of main group metal elements, for example Na, TI, Sn, Pb, Sb and Bi. Examples of suitable phosphors include phosphors based on garnet, silicate, orthosilicate, thiogallate, sulfide, nitride, silicon-based oxynitride, nitridosilicate, nitridoaluminumsilicate, oxonitridosilicate, oxonitridoaluminumsilicate and rare earth doped sialon. Phosphors within the meaning of the present application are materials which absorb electromagnetic radiation of a specific wavelength range, preferably blue and/or ultraviolet (UV) electromagnetic radiation and convert the absorbed electromagnetic radiation into electromagnetic radiation having a different wavelength range, preferably visible (VIS) light such as violet, blue, green, yellow, orange, or red light, or the near infrared light (NIR).

Here, the term “UV” is electromagnetic radiation with a wavelength from 100 nm to 389 nm, shorter than that of visible light but longer than X-rays.

The term “VIS” is electromagnetic radiation with a wavelength from 390 nm to 700 nm.

The term “NIR” is electromagnetic radiation with a wavelength from 701 nm to 1,000 nm.

The term “semiconductor nanoparticle” in the present application denotes a crystalline nanoparticle which consists of a semiconductor material. Semiconductor nanoparticles are also referred to as quantum materials in the present application. They represent a class of nanomaterials with physical properties that are widely tunable by controlling particle size, composition and shape. Among the most evident size dependent property of this class of materials is the tunable fluorescence emission. The tunability is afforded by the quantum confinement effect, where reducing particle size leads to a “particle in a box” behavior, resulting in a blue shift of the band gap energy and hence the light emission. For example, in this manner, the emission of CdSe nanocrystals can be tuned from 660 nm for particles of diameter of ˜6.5 nm, to 500 nm for particles of diameter of ˜2 nm. Similar behavior can be achieved for other semiconductors when prepared as nanocrystals allowing for broad spectral coverage from the UV (using ZnSe, CdS for example) throughout the visible (using CdSe, InP for example) to the near-IR (using InAs for example).

Semiconductor nanoparticles may have an organic ligand on the outermost surface of the nanoparticles.

According to the present invention, the term “transparent” means at least around 60% of incident light transmittal.

Preferably, it is over 70%, more preferably, over 75%, the most preferably, it is over 80%.

### BRIEF DESCRIPTION OF DRAWINGS

FIG. 1: shows a cross sectional view of a schematic of one embodiment of the present invention.

FIG. 2a: shows a top view of a schematic of one embodiment of an optical medium (100) of the invention when no tensile force is applied.

FIG. 2b: shows a top view of a schematic of an optical medium (200) of the invention when a tensile force is applied.

FIG. 3: shows a cross sectional view of a schematic of an optical medium (200) of the invention.

FIG. 4: shows a cross sectional view of a schematic of an optical medium (300) of the invention.

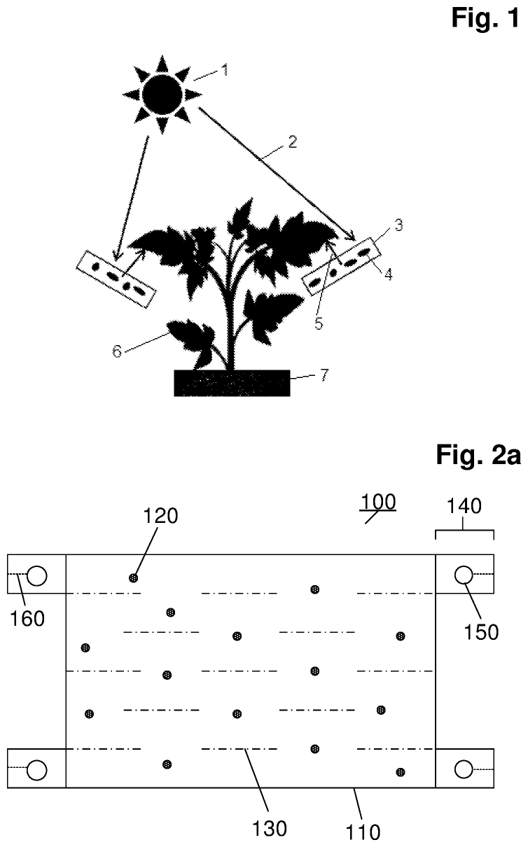

List of reference signs in FIG. 1
1. the sun (an artificial light source can be used instead of the sun)
2. sun light
3. a light converting medium
4. a light modulating material
5. light from a light modulating material
6. a leaf of a plant
7. soil

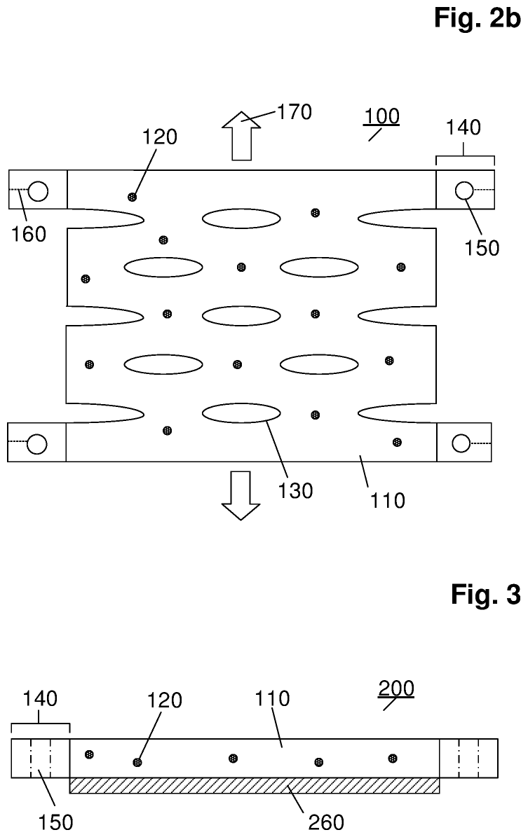

List of reference signs in FIG. 2a
100. a light converting medium
110. light converting part
120. a light modulating material
130. a slit (optional)
140. an attaching part (optional)
150. a hole (optional)
160. a slit (optional)

List of reference signs in FIG. 2b
100. a light converting medium
110. light converting part
120. a light modulating material
130. a slit (optional)
140. an attaching part (optional)
150. a hole (optional)
160. a slit (optional)
170. a tensile direction

List of reference signs in FIG. 3
200. a light converting medium
110. light converting part
120. a light modulating material
140. an attaching part (optional)
150. a hole (optional)
260. a reflection layer (optional)

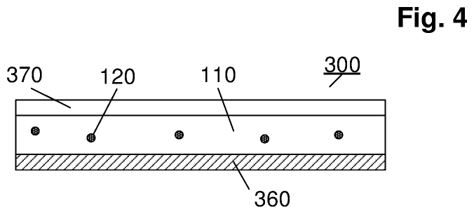

List of reference signs in FIG. 4
300. a light converting medium
110. light converting part
120. a light modulating material
360. a reflection layer (optional)
370. an adhesive layer (optional)

### DETAILED EXPLANATION OF THE INVENTION

According to the present invention, the method for controlling a condition of a plant comprises, essentially consists of, or consists of following steps i) and ii),
i) absorbing at least a part of light that passed through a leaf of a plant with one or more of light modulating materials, one or more of compositions comprising at least one light modulating material and/or one or more of light converting mediums comprising at least one light modulating material,
wherein said at least one light modulating material, one composition comprising at least one light modulating material and/or one light converting medium comprising at least one light modulating material, is placed at least a part of the underside of a leaf;
ii) irradiating at least a part of the underside surface of a leaf of a plant with light emitted and/or with light selectively reflected from the light modulating material.

In a preferred embodiment of the present invention, said composition and/or the light converting medium comprise a plurality of the light converting medium.

The inventors have newly found that new and more efficient method for controlling a condition of a plant by the materials placed behind the leaf where the transmitted light through a leaf is irradiated.

As a result of intensive studies, the present inventors have found a suitable light emitting/reflection materials for the purpose of the present invention. It is modulating a condition of a plant by enhancing the optimal wavelength which are blue, red or infrared in color. The inventors also found a suitable device structure of the light converting medium. This material also possesses good resistance to the environment.

By placing the light modulating material of the present invention itself or in the form of composition or light converting medium, directly behind the plants, it is believed that it can more efficiently control the growth of plants due to a structure of a leaf and it can re-use the light that passed through a leaf of a plant.

In some embodiments of the present invention, the light emitted from or selectively reflected from the light modulating material has the peak maximum light wavelength in the range of less than 500 nm and/or more than 600 nm, preferably in the range from 400 nm to 500 nm and/or from 600 nm to 750 nm.

More preferably, the emission peak maximum wavelength is in the range from 430 to 500 nm and/or 600 to 730 nm.

According to the present invention, said light irradiation with light emitted and/or with light selectively reflected from the light modulating material is performed by placing at least one light modulating material, a composition comprising at least one light modulating material and/or a light converting medium of the present invention directly backside of a leaf of a plant in a close distance to effectively absorb and/or reflect light from the backside of a leaf and more effectively emit or selectively reflect the light to the backside of the leaf without causing any big decrease of the intensity of the peak maximum light emission wavelength.

Thus, in a preferable embodiment of the present invention, the light modulating material, the composition and/or the light converting medium is placed directly onto the underside surface of a leaf of a plant or within 15 cm from the underside surface of a leaf of a plant in step i) and/or in step ii), preferably the distance between the underside surface of a leaf of a plant and the light modulating material is in the range from 0 cm to 15 cm, more preferably 0.01 cm to 15 cm, even more preferably from 0.1 cm to 10 cm, even more preferably in the range from 0.1 cm to 5 cm.

It is believed that it leads improved efficiency of light emitted or reflected from the light modulating material and reduces damping of the light intensity from the light modulating material since it is set directly onto or near to the underside of a leaf.

A method for placing the light modulating material and/or the composition onto at least a part of a backside of a leaf of a plant is characterized by using a spray method in order to place a plant growth regulating solution on the backside of a leaf of a plant. Preferably, whole part of the backside of a leaf of a plant is coated by the light modulating material and/or the composition.

According to the present invention, a direct coating method using brush can also be used in order to place the light modulating material and/or the composition onto at least a part of a backside of a leaf of a plant.

The functional phosphors or pigments solution can be sprayed on the plants so that it can emit light or reflect an incident light towards the underside of a leaf of a plant more effectively and to control plant condition e.g. promoting plant growth and adjusting the amount of plant chemicals.

In some embodiments of the present invention, the light modulating material and/or the light converting medium is coated by an adhesive material.

In some embodiments of the present invention, the composition further comprises an adhesive material.

According to the present invention, publicly available optically transparent adhesive material can be used preferably. Preferably, said adhesive material is transparent at least at the peak light wavelength emitted or reflected by the light modulating material.

### Light Modulating Material

According to the present invention, the light modulating material can preferably be selected from pigments, dyes and luminescent materials, preferably the light modulating material is a luminescent material, more preferably the light modulating material is a luminescent material selected from organic materials or inorganic materials, even more preferably the light modulating material is an inorganic material selected from phosphors or semiconductor nanoparticles.

In some embodiments of the present invention, said pigment is a publicly available light control pigment preferably. More preferably said light control pigment is a publicly available pearl pigment, which reflects a light having a wavelength in the range from 430 to 500 nm and/or from 600 to 730 nm. It's higher than the plant growth regulation and any other visible light range. The plant growth regulating substance characterized in that is the wavelength adjusting substance that has functions of both a fluorescent substance and a light controlling material.

### Organic Fluorescent Material

It is available to use the Phosphor materials described in Phosphor handbook (Yen, Shionoya, Yamamoto). Especially, it is desirable (preferable) to be the organic phosphor material of Fluoresceins Rhodamines, Cumarins, Pyrenes, Cyanines, Perylenes, Di-cyano-methylenes that emit a luminescence in the range of long wave-length containing red color area. It is also available to use the luminescence material.

### Inorganic Phosphors

According to the present invention, any type of publicly known inorganic phosphors, such as described in the second chapter of Phosphor handbook (Yen, Shionoya, Yamamoto), having a peak maximum light wavelength of light emitted from the inorganic phosphor in the range of 600 nm or more, preferably in the range from 600 to 1500 nm, more preferably in the range from 650 to 1000 nm, even more preferably in the range from 600 to 800 nm, furthermore preferably in the range from 600 to 750 nm, much more preferably it is from 660 nm to 730 nm, furthermore preferably it is from 660 nm to 710 nm, the most preferably from 670 nm to 710nm,
and/or at least one inorganic phosphor having a peak maximum light wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,
and/or at least one inorganic phosphor having a first peak maximum light wavelength of light emitted from the inorganic phosphor in the range of 500 nm or less, and a second peak maximum light wavelength of light emitted from the inorganic phosphor in the range of 600 nm or more, preferably the first peak maximum light wavelength of light emitted from the inorganic phosphor is in the range from 250 nm to 500 nm, and the second peak light emission wavelength is in the range from 600 nm to 1500 nm, more preferably the first peak maximum light wavelength of light emitted from the inorganic phosphor is in the range from 300 nm to 500 nm, and the second peak light emission wavelength is in the range from 600 nm to 1000 nm, even more preferably the first peak maximum light wavelength of light emitted from the inorganic phosphor is in the range from 350nm to 500 nm, and the second peak light emission wavelength is in the range from 600 nm to 800 nm, furthermore preferably the first peak maximum light wavelength of light emitted from the inorganic phosphor is in the range from 400 nm to 500nm, and the second peak light emission wavelength is in the range from 600 nm to 750 nm, much more preferably the first peak maximum light wavelength of light emitted from the inorganic phosphor is in the range from 420 nm to 480 nm, and the second peak light emission wavelength is in the range from 660 nm to 740 nm, the most preferably the first peak maximum light wavelength of light emitted from the inorganic phosphor is in the rage from 430 nm to 460 nm and the second peak maximum light wavelength of light emitted from the inorganic phosphor is in the range from 660 nm to 710 nm, can be used preferably.

It is believed that the peak maximum light wavelength of the light emitted from the phosphor in the rage 660 nm to 710 nm is specifically useful for plant growth.

As used in the present application, the terms “inorganic phosphor” which are used as synonyms here, denote a fluorescent inorganic material in particle form having one or more emitting centres. The emitting centres are formed by activators, usually atoms or ions of a rare-earth metal element, such as, for example, La, Ce, Pr, Nd, Pm, Sm, Eu, Gd, Tb, Dy, Ho, Er, Tm, Yb and Lu, and/or atoms or ions of a transition-metal element, such as, for example, Cr, Mn, Fe, Co, Ni, Cu, Ag, Au and Zn, and/or atoms or ions of a main-group metal element, such as, for example, Na, TI, Sn, Pb, Sb and Bi. Examples of phosphors include garnet-based phosphors, silicate-based, orthosilicate-based, thiogallate-based, sulfide-based and nitride-based phosphors. The phosphor materials can be phosphor particles with or without silicon dioxide coating. A phosphor in the sense of the present application is taken to mean a material which absorbs radiation in a certain wavelength range of the electromagnetic spectrum, preferably in the blue or UV spectral range, and emits visible light or far red light in another wavelength range of the electromagnetic spectrum, preferably in the violet, blue, green, yellow, orange, red spectral range or far red spectral range. The term “radiation-induced emission efficiency” should also be understood in this connection, i.e. the phosphor absorbs radiation in a certain wavelength range and emits radiation in another wavelength range with a certain efficiency. The term “shift of the emission wavelength” is taken to mean that a phosphor emits light at a different wavelength compared with another, i.e. shifted towards a shorter or longer wavelength.

A wide variety of phosphors come into consideration for the present invention, such as, for example, metal-oxide phosphors, silicate and halide phosphors, phosphate and halophosphate phosphors, borate and borosilicate phosphors, aluminate, gallate and alumosilicate phosphors, phosphors, sulfate, sulfide, selenide and telluride phosphors, nitride and oxynitride phosphors and SiAlON phosphors.

In some embodiments of the present invention, the phosphor is selected from the group consisting of metal-oxide phosphors, silicate and halide phosphors, phosphate phosphors, borate and borosilicate phosphors, aluminate, gallate and alumosilicate phosphors, sulfate, sulfide, selenide and telluride phosphors, nitride and oxynitride phosphors and SiAlON phosphors, preferably, it is a metal oxide phosphor, more preferably it is a Mn activated metal oxide phosphor or a Mn activated phosphate based phosphor, even more preferably it is a Mn activated metal oxide phosphor.

Preferred metal-oxide phosphors are arsenates, germanates, halogermanates, indates, lanthanates, niobates, scandates, stannates, tantalates, titanates, vanadates, halovanadates, phosphovanadates, yttrates, zirconates, molybdate and tungstate.

Even more preferably, it is a metal oxide phosphor, more preferably it is a Mn activated metal oxide phosphor or a Mn activated phosphate based phosphor, even more preferably it is a Mn activated metal oxide phosphor.

Thus, in some embodiments of the present invention, said inorganic phosphor is selected from the group consisting of metal oxides, silicates and halosilicates, phosphates and halophosphates, borates and borosilicates, aluminates, gallates and alumosilicates, molybdates and tungstates, sulfates, sulfides, selenides and tellurides, nitrides and oxynitrides, SiAlONs, halogen compounds and oxy compounds, such as preferably oxysulfides or oxychlorides phosphors, preferably, it is a metal oxide phosphor, more preferably it is a Mn activated metal oxide phosphor or a Mn activated phosphate based phosphor, even more preferably it is a Mn activated metal oxide phosphor.

For example, the inorganic phosphor is selected from the group consisting of Al₂O₃:Cr³⁺, Y₃Al₅O₁₂:Cr³⁺, MgO:Cr³⁺, ZnGa₂O₄:Cr³⁺, MgAl₂O₄:Cr³⁺, Gd₃Ga₅O₁₂:Cr³⁺, LiAl₅O₈:Cr³⁺, MgSr₃Si₂O₈:Eu²⁺, Mn²⁺, Sr₃MgSi₂O₈:Mn⁴⁺, Sr₂MgSi₂O₇:Mn⁴⁺, SrMgSi₂O₆:Mn⁴⁺, BaMg₆Ti₆O₁₉:Mn⁴⁺, Ca₁₄Al₁₀Zn₆O₃₅:Mn⁴⁺, Mg₈Ge₂O₁₁F₂:Mn⁴⁺, Mg₂TiO₄:Mn⁴⁺, Y₂MgTiO₆:Mn⁴⁺, Li₂TiO₃:Mn⁴⁺, K₂SiF₆:Mn⁴⁺, K₃SiF₇:Mn⁴⁺, K₂TiF₆:Mn⁴⁺, K₂NaAlF₆:Mn⁴⁺, BaSiF₆:Mn⁴⁺, CaAl₁₂O₁₉:Mn⁴⁺, MgSiO₃:Mn²⁺, Si₅P₆O₂₅:Mn⁴⁺, NaLaMgWO₆:Mn⁴⁺, Ba₂YTaO₆:Mn⁴⁺, ZnAl₁₂O₄:Mn²⁺, CaGa₂S₄:Mn²⁺, CaAlSiN₃:Eu²⁺, SrAlSiN₃:Eu²⁺, Sr₂Si₅N₈:Eu²⁺, SrLiAlN₄:Eu²⁺, CaMgSi₂O₆:Eu²⁺, Sr₂MgSi₂O₇:Eu²⁺, SrBaMgSi₂O₇:Eu²⁺, Ba₃MgSi₂O₈:Eu²⁺, LiSrPO₄:Eu²⁺, LiCaPO₄:Eu²⁺, NaSrPO₄:Eu²⁺, KBaPO₄:Eu²⁺, KSrPO₄:Eu²⁺, KMgPO₄:Eu²⁺, α-Sr₂P₂O₇:Eu²⁺, α-Ca₂P₂O₇:Eu²⁺, Mg₃(PO₄)₂:Eu²⁺, Mg₃Ca₃(PO₄)₄:Eu²⁺, BaMgAl₁₀O₁₇:Eu²⁺, SrMgAl₁₀O₁₇:Eu²⁺, AlN:Eu²⁺, Sr₅(PO₄)₃Cl:Eu²⁺, NaMgPO₄ (glaserite):Eu²⁺, Na₃Sc₂(PO₄)₃:Eu²⁺, LiBaBO₃:Eu²⁺, SrAlSi₄N₇:Eu²⁺, Ca₂SiO₄:Eu²⁺, NaMgPO₄:Eu²⁺, CaS:Eu²⁺, Y₂O₃:Eu³⁺, YVO₄:Eu³⁺, LiAlO₂:Fe³⁺, LiAl₅O₈:Fe³⁺, NaAlSiO₄:Fe³⁺, MgO:Fe³⁺, Gd₃Ga5O12:Cr³⁺, Ce³⁺, (Ca, Ba, Sr)₂MgSi₂O₇:Eu, Mn, CaMgSi₂O₆:Eu²⁺, Mn²⁺, NaSrBO₃:Ce³⁺, NaCaBO₃:Ce³⁺, Ca₃(BO₃)₂:Ce³⁺, Sr₃(BO₃)₂:Ce³⁺, Ca₃Y(GaO)₃(BO₃)₄:Ce³⁺, Ba₃Y(BO₃)₃:Ce³⁺, CaYAlO₄:Ce³⁺, Y₂SiO₅:Ce³⁺, YSiO₂N:Ce³⁺, Y₅(SiO₄)₃N:Ce³⁺, Ca₂Al₃O₆FGd₃Ga₅O₁₂:Cr³⁺, Ce³⁺, ZnS, InP/ZnS, CuInS₂, CuInSe₂, CuinS₂/ZnS, carbon/graphen quantum dots and a combination of any of these as described in the second chapter of Phosphor handbook (Yen, Shinoya, Yamamoto).

As one embodiment of the invention, a phosphor or its denaturated (e.g., degraded) substance which less harms animals, plants and/or environment (e.g., soil, water) is desirable.

Thus, one embodiment of the invention, the phosphor is nontoxic phosphors, preferably it is edible phosphors, more preferably as edible phosphors, MgSiO₃:Mn²⁺, MgO:Fe³⁺, CaMgSi₂O₆:Eu²⁺, Mn²⁺ are useful.

According to the present invention the term “edible” means safe to eat, fit to eat, fit to be eaten, fit for human consumption.

In some embodiments, as a phosphate based phosphor, a new light emitting phosphor represented by following general formula (VII) which can exhibit deep red-light emission, preferably with a sharp emission around 700 nm under excitation light of 300 to 400 nm, which are suitable to promote plant growth, can be used preferably.

A₅P₆O₂₅:Mn (VII)

wherein the component “A” stands for at least one cation selected from the group consisting of Si⁴⁺, Ge⁴⁺, Sn⁴⁺, Ti⁴⁺and Zr⁴⁺.

Or the phosphor can be represented by following chemical formula (VII′).

(A₁₋ₓMnₓ)₅P₆O₂₅ (VII′)

The component A stands for at least one cation selected from the group consisting of Si⁴⁺, Ge⁴⁺, Sn⁴⁺, Ti⁴⁺and Zr⁴⁺, preferably A is Si⁴⁺; 0<x≤0.5, preferably 0.05<x≤0.4.

In a preferred embodiment of the present invention, Mn of formula (VII) is Mn4⁺.

In a preferred embodiment of the present invention, the phosphor represented by chemical formula is Si₅P₆O₂₅:Mn⁴⁺.

Said phosphor represented by chemical formula (VII) or (VII′) can be fabricated by the following method comprising at least the following steps (w) and (x);
(w) mixing a source of the component A in the form of an oxide, and a source of the activator selected from one or more members of the group consisting of MnO₂, MnO, MnCO₃, Mn(OH)₂, MnSO₄, Mn(NO₃)₂, MnCl₂, MnF₂, Mn(CH₃COO)₂ and hydrates of MnO₂, MnO, MnCO₃, Mn(OH)₂, MnSO₄, Mn(NO₃)₂, MnCl₂, MnF₂, Mn(CH₃COO)₂;
and at least one material selected from the group consisting of inorganic alkali, alkaline-earth, ammonium phosphate and hydrogen phosphate, preferably the materials is ammonium dihydrogen phosphate, in a molar ratio of A:Mn:P=5x: 5(1−x):6, wherein 0<x≤0.5, preferably 0.01<x≤0.4; more preferably 0.05<x≤0.1, to get a reaction mixture,
(x) subjecting said mixture(s) to calcination at the temperature in the range from 600 to 1.500° C., preferably in the range from 800 to 1.200° C., more preferably in the range from 900 to 1.100° C.

As a mixer, any publicly known powder mixing machine can be used preferably in step (w).

In a preferred embodiment of the present invention, said calcination step (x) is carried out under atmospheric pressure in the presence of oxygen, more preferably under air condition.

In a preferred embodiment of the present invention, said calcination step (x) is carried out for the time at least one hour, preferably in the range from 1 hour to 48 hours, more preferably it is from 6 hours to 24 hours, even more preferably from 10 hours to 15 hours.

After the time period of step (x), the calcinated mixture is cooled down to room temperature.

In a preferred embodiment of the present invention, a solvent is added in step (w) to get a better mixture condition. Preferably said solvent is an organic solvent, more preferably it is selected from one or more members of the group consisting of alcohols such as ethanol, methanol, ipropan-2-ol, butan-1-ol; ketones such as acetone, 2-hexanone, butanone, ethyl isopropyl ketone.

In a preferred embodiment of the present invention, the method further comprises following step (y) after step (w) before step (x):
(y) subjecting the mixture from step (w) to pre-calcination at the temperature in the range from 100 to 500° C., preferably in the range from 200 to 400° C., even more preferably from 250 to 350° C.

Preferably it is carried out under atmospheric pressure and in the presence of oxygen, more preferably under air condition.

In a preferred embodiment of the present invention, said calcination step (y) is carried out for the time at least 1 hour, preferably from 1 hour to 24 hours, more preferably in the range from 1 hour to 15 hours, even more preferably it is from 3 hours to 10 hours, furthermore preferably from 5 hours to 8 hours.

After the time period, pre-calcinated mixture is cooled down to a room temperature preferably.

In a preferred embodiment of the present invention, the method additionally comprises following step (w′) after pre-calcination step (y),
(w′) mixing a mixture obtained from step (y) to get a better mixing condition of the mixture.

As a mixer, any publicly known powder mixing machine can be used preferably in step (w′).

In a preferred embodiment of the present invention, the method further comprises following step (z) before step (x) after step (w), preferably after step (w′),
(z) molding said mixture from step (w) or (y) into a compression molded body by a molding apparatus,

In a preferred embodiment of the present invention, the method optionally comprises following step (v) after step (x),
(v) grinding obtained material.

As a molding apparatus, a publicly known molding apparatus can be used preferably.

In some embodiments, as a metal oxide phosphor, another new light emitting phosphor represented by following general formula (VIII), (IX) or (X) which can exhibit deep red-light emission, preferably with a sharp emission around 700 nm under excitation light of 300 to 400 nm, which are suitable to promote plant growth, can be used preferably.

XO₆ (VIII)

where X=(A¹)₂B¹(C¹₍₁₋ₓ₎Mn⁴⁺_{5/4x}), or X=A²B²C²(D¹_{(1-y)}Mn⁴⁺_{1.5y}), 0<x≤0.5, 0<y≤0.5;

A¹₂B¹C¹O₆:Mn (IX)

A²B²C²D¹O₆:Mn (X)
A¹=at least one cation selected from the group consisting of Mg²⁺, Ca²⁺, Sr²⁺ and Ba²⁺Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺;
A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B³⁺, Al³⁺ and Ga³⁺, preferably B² is La³⁺;
C²=at least one cation selected from the group consisting of Mg²⁺, Ca²⁺, Sr²⁺, Ba²⁺ and Zn²⁺, preferably C² is Mg²⁺;
D¹=at least one cation selected from the group consisting of Mo⁶⁺ and W⁶⁺, preferably D¹ is W⁶⁺.

In a preferred embodiment of the present invention, Mn is Mn4+, more preferably, the phosphor represented by chemical formula (X) is NaLaMgWO₆:Mn⁴⁺ and the phosphor represented by chemical formula (IX) Ba₂YTaO₆:Mn⁴⁺.

Said phosphor represented by chemical formula (VIII) or (IX) can be fabricated by the following method comprising at least the following steps (w″) and (x′); (w″) mixing sources of components A¹, B¹, C¹, or A², B², C², and D¹ in the form of solid oxides and/or carbonates;
and a source of Mn activator selected from one or more members of the group consisting of MnO₂, MnO, MnCO₃, Mn(OH)₂, MnSO₄, Mn(NO₃)₂, MnCl₂, MnF₂, Mn(CH₃COO)₂ and hydrates of MnO₂, MnO, MnCO₃, Mn(OH)₂, MnSO₄, Mn(NO₃)₂, MnCl₂, MnF₂, Mn(CH₃COO)₂;
in a molar ratio of either

A¹:B¹:Cl:Mn=2:1:(1−x):x or

A²:B²:C²:D¹:Mn=1:1:1:(1−y):y (0<y≤0.5);

wherein 0<x≤0.5, 0<y≤0.5, preferably 0.01<x≤0.4, 0.01<y≤0.4; more preferably 0.05<x≤0.1, 0.05<y≤0.1; to get a reaction mixture,
(x′) subjecting said mixture to calcination at the temperature in the range from 1,000 to 1,600° C., preferably in the range from 1,100 to 1,500° C., more preferably in the range from 1,200 to 1,400° C.

Preferably, when preparing phosphors according to general formula (IX) mixtures are preferred comprising component A¹ in the form of their oxides (MgO, ZnO) or carbonates (CaCO₃, SrCO₃, BaCO₃), and the remaining components B¹, C¹ an Mn in the form of their oxides (Sc₂O₃, Y₂O₃, La₂O₃, Ce₂O₃, B₂O₃, Al₂O₃, Ga₂O₃ on one hand and V₂O₅, Nb₂O₅, Ta₂O₅ and MnO₂ on the other). In case of lanthanum oxide, it is advantageous to pre-heat the material at 1.200° C. for 10 hours.

Preferably when preparing phosphors according to general formula (X) mixtures are preferred comprising component A² and C² in the form of their oxides (MgO, ZnO) or carbonates (Li₂CO_{3,} Na₂CO₃, K₂CO₃, Rb₂CO₃, Cs₂CO₃, CaCO₃, SrCO₃, BaCO₃), and the remaining components B², D² and

Mn in the form of their oxides (Sc₂O₃, La₂O₃, Ce₂O₃, B₂O₃, Al₂O₃, Ga₂O₃ on one hand and MoO₃, WO₃ and MnO₂ on the other).

As a mixer, any publicly known powder mixing machine can be used preferably in step (w).

In a preferred embodiment of the present invention, said calcination step (x′) is carried out under atmospheric pressure in the presence of oxygen, more preferably under air condition.

In a preferred embodiment of the present invention, said calcination step (x′) is carried out for the time at least one hour, preferably in the range from 1 hour to 48 hours, more preferably it is from 6 hours to 24 hours, even more preferably from 10 hours to 15 hours.

After the time period of step (x′), the calcinated mixture is cooled down to room temperature.

In a preferred embodiment of the present invention, a solvent is added in step (w″) to get a better mixture condition. Preferably said solvent is an organic solvent, more preferably it is selected from one or more members of the group consisting of alcohols such as ethanol, methanol, ipropan-2-ol, butan-1-ol; ketones such as acetone, 2-hexanone, butanone, ethyl isopropyl ketone.

In a preferred embodiment of the present invention, the method further comprises following step (y′) after step (w″) before step (x′):
(y′) subjecting the mixture from step (w″) to pre-calcination at the temperature in the range from 100 to 500° C., preferably in the range from 200 to 400° C., even more preferably from 250 to 350° C.

Preferably it is carried out under atmospheric pressure and in the presence of oxygen, more preferably under air condition.

In a preferred embodiment of the present invention, said calcination step (y′) is carried out for the time at least 1 hour, preferably from 1 hour to 24 hours, more preferably in the range from 1 hour to 15 hours, even more preferably it is from 3 hours to 10 hours, furthermore preferably from 5 hours to 8 hours.

After the time period, pre-calcinated mixture is cooled down to a room temperature preferably.

In a preferred embodiment of the present invention, the method additionally comprises following step (w″′) after pre-calcination step (y′),
(w″′) mixing a mixture obtained from step (y′) to get a better mixing condition of the mixture.

As a mixer, any publicly known powder mixing machine can be used preferably in step (w″′).

In a preferred embodiment of the present invention, the method further comprises following step (z′) before step (x′) after step (w″), preferably after step (w″′),
(z′) molding said mixture from step (w) or (y) into a compression molded body by a molding apparatus.

In a preferred embodiment of the present invention, the method optionally comprises following step (v′) after step (x′),
(v′) grinding obtained material.

As a molding apparatus, a publicly known molding apparatus can be used preferably.

In some embodiments of the present invention, the inorganic phosphors can emit a light having the peak maximum light wavelength of light emitted from the inorganic phosphor in the range from 600 nm to 710 nm, preferably it is from 660 nm to 710 nm.

It is believed that the peak maximum light wavelength of light emitted from the inorganic phosphor in the range from 660 nm to 710 nm is very suitable for plant condition control, especially for plant growth promotion. Without wishing to be bound by theory, it is believed that the inorganic phosphor having at least one light absorption peak maximum light wavelength in UV and/or purple light wavelength region from 300 nm to 430 nm may keep harmful insects off plants.

Therefore, in some embodiments of the present invention, the inorganic phosphor can have at least one light absorption peak maximum light wavelength in UV and/or purple light wavelength reason from 300 nm to 430 nm.

In some embodiments of the present invention, from the viewpoint of improved plant growth and improved homogeneous of blue and red (or infrared) light emission from the composition or from the light converting sheet, an inorganic phosphor having a first peak maximum light wavelength of light emitted from the inorganic phosphor in the range from 400 nm to 500 nm and a second peak maximum light wavelength of light emitted from the inorganic phosphor from 650 nm to 750 nm can be used preferably.

More preferably, the inorganic phosphor having the first peak maximum light wavelength of light emitted from the inorganic phosphor is in the range from 430 nm to 490 nm, and the second peak light emission wavelength is in the range from 660 nm to 740 nm, more preferably the first peak maximum light wavelength of light emitted from the inorganic phosphor is 450 nm and the second peak maximum light wavelength of light emitted from the inorganic phosphor is in the range from 660 nm to 710 nm, is used.

Preferably, said at least one inorganic phosphor is a plurality of inorganic phosphor having the first and second peak maximum light wavelength of light emitted from the inorganic phosphor, or a plurality of inorganic phosphor having the first and second peak maximum light wavelength of light emitted from the inorganic phosphor, or a combination of these.

It is believed that the Mn⁴⁺ activated metal oxide phosphors, Mn, Eu activated metal oxide phosphors, Mn²⁺ activated metal oxide phosphors, Fe³⁺ activated metal oxide phosphors can be used preferably from the viewpoint of environmentally friendly since these phosphors do not create Cr⁶⁺ during synthesis procedure.

Without wishing to be bound by theory, it is believed that the Mn⁴⁺ activated metal oxide phosphors are very useful for plant growth, since it shows narrow full width at half maximum (hereafter “FWHM”) of the light emission, and have the peak absorption wavelength in UV and green wavelength region such as 350 nm and 520 nm, and the emission peak maximum light wavelength is in near infrared ray region such as from 650 nm to 730 nm, More preferably, it is from 670 nm to 710 nm.

In other words, without wishing to be bound by theory, it is believed that the Mn⁴⁺ activated metal oxide phosphors can absorb the specific UV light which attracts insects, and green light which does not give any advantage for plant growth, and can convert the absorbed light to longer wavelength in the range from 650 nm to 750 nm, preferably it is from 660 nm to 740 nm, more preferably from 660 nm to 710 nm, even more preferably from 670 nm to 710 nm, which can effectively accelerate plant growth.

From that point of view, even more preferably, the inorganic phosphor can be selected from Mn activated metal oxide phosphors.

In a further preferred embodiment of the present invention, the inorganic phosphor is selected from one or more of Mn activated metal oxide phosphors or Mn activated phosphate based phosphors represented by following formulae (I) to (VI),

AₓB_{y}O_{z}:Mn⁴⁺ (I)

wherein A is a divalent cation and is selected from one or more members of the group consisting of Mg²⁺, Zn²⁺, Cu²⁺, Fe²⁺, Ca²⁺, Sr²⁺, Ba²⁺, Mn²⁺, Ce²⁺ and Sn²⁺, B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4, more preferably, formula (I) is Mg₂TiO₄:Mn⁴⁺;

XₐZ_{b}O_{c}:Mn⁴⁺ (II)

wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3, more preferably formula (II) is Li₂TiO₃:Mn⁴⁺;

D_{d}EₑO_{f}:Mn⁴⁺ (III)

wherein D is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; E is a trivalent cation and is selected from the group consisting of Al³⁺, Ga³⁺, Lu³⁺, Sc³⁺, La³⁺ and In³⁺; e≥10; d≥0; (d+1.5e)=f, preferably D is Ca²⁺, Sr²⁺, Ba²⁺ or a combination of any of these, E is Al³⁺, Gd³⁺ or a combination of these, d is 1, e is 12, f is 19, more preferably formula (III) is CaAl₁₂O₁₉:Mn⁴⁺;

D_{g}EₕOᵢ:Mn⁴⁺ (IV)

wherein D is a trivalent cation and is selected from one or more members of the group consisting of Al³⁺, Ga³⁺, Lu³⁺, Sc³⁺, La³⁺and In³⁺; E is a trivalent cation and is selected from the group consisting of Al³⁺, Ga³⁺, Lu³⁺, Sc3+, La³⁺ and In³⁺; h≥0; a≥g; (1.5g+1.5h)=I, preferably D is La³⁺, E is Al³⁺, Gd³⁺ or a combination of these, g is 1, h is 12, i is 19, more preferably formula (IV) is LaAlO₃:Mn⁴⁺;

GⱼJₖLₗOₘ:Mn⁴⁺ (v)

wherein G is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga³⁺, Lu³⁺, Sc³⁺, La³⁺ and In³⁺; L is a trivalent cation and is selected from the group consisting of Al³⁺, Ga³⁺, Lu³⁺, Sc³⁺, La³⁺ and In³⁺; l≥0; k≥0; j≥0; (j+1.5k+1.51)=m, preferably G is selected from Ca²⁺, Sr²⁺, Ba²⁺ or a combination of any of these, J is Y³⁺, Lu³⁺ or a combination of these, L is Al³⁺, Gd³⁺ or a combination of these, j is 1, k is 1, I is 1, m is 4, more preferably it is CaYAlO₄:Mn⁴⁺;

MₙQₒRₚO_{q}:Eu, Mn (VI)

wherein M and Q are divalent cations and are, independently or dependently of each other, selected from one or more members of the group consisting of Mg²⁺, Zn²⁺, Cu²⁺, Co²⁺, Ni²⁺, Fe²⁺, Ca²⁺, Mn²⁺, Ce²⁺; R is Ge³⁺, Si³⁺, or a combination of these; n≥1; o≥0; p≥1; (n+o++2.0p)=q, preferably M is Ca²⁺, is Mg²⁺, Ca²⁺Zn²⁺ or a combination of any of these, R is Si³⁺, n is 1, o is 1, p is 2, q is 6, more preferably it is CaMgSi₂O₆:Eu²⁺, Mn²⁺;

A₅P₆O₂₅: Mn⁴⁺ (VII)

wherein the component “A” stands for at least one cation selected from the group consisting of Si⁴⁺, Ge⁴⁺, Sn⁴⁺, Ti⁴⁺and Zr⁴⁺;

A¹₂B¹C¹O₆:Mn⁴⁺ (IX)

A¹=at least one cation selected from the group consisting of Mg²⁺, Ca²⁺, Sr²⁺ and Ba²⁺Zn²⁺, preferably A¹ is Ba²⁺;
B¹=at least one cation selected from the group consisting of Sc³⁺, Y³⁺, La³⁺, Ce³⁺, B³⁺, Al³⁺ and Ga³⁺, preferably B¹ is Y³⁺;
C¹=at least one cation selected from the group consisting of V⁵⁺, Nb⁵⁺ and Ta⁵⁺, preferably C¹ is Ta⁵⁺; and

A²B²C²D¹O₆:Mn⁴⁺ (X)

A²=at least one cation selected from the group consisting of Li⁺, Na⁺, K⁺, Rb⁺ and Cs⁺, preferably A² is Na⁺;
B²=at least one cation selected from the group consisting of Sc³⁺, La³⁺, Ce³⁺, B³⁺, Al³⁺ and Ga³⁺, preferably B² is La³⁺;
C²=at least one cation selected from the group consisting of Mg²⁺, Ca²⁺, Sr²⁺, Ba²⁺and Zn²⁺, preferably C² is Mg²⁺;
D¹=at least one cation selected from the group consisting of Mo⁶⁺ and W⁶⁺, preferably D¹ is W⁶⁺.

A Mn activated metal oxide phosphor represented chemical formula (VI) is more preferable since it emits a light with a first peak maximum light wavelength of light emitted from the inorganic phosphor in the range of 500 nm or less, and a second peak maximum light wavelength of light emitted from the inorganic phosphor in the range of 650 nm or more, preferably the first peak maximum light wavelength of light emitted from the inorganic phosphor is in the range from 400 nm to 500 nm, and the second peak light emission wavelength is in the range from 650 nm to 750 nm, more preferably the first peak maximum light wavelength of light emitted from the inorganic phosphor is in the range from 420 nm to 480 nm, and the second peak light emission wavelength is in the range from 660 nm to 740 nm, even more preferably the first peak maximum light wavelength of light emitted from the inorganic phosphor is in the rage from 430 nm to 460 nm and the second peak maximum light wavelength of light emitted from the inorganic phosphor is in the range from 660 nm to 710 nm.

In a preferred embodiment of the present invention, said phosphor is a Mn activated metal oxide phosphor or a phosphate based phosphor represented by chemical formula (I), (VII), (IX) or (X).

In some preferred embodiments of the present invention, the inorganic phosphor can be a Mn activated metal oxide phosphor selected from the group consisting of Mg₂TiO₄:Mn⁴⁺, Li₂TiO₃:Mn⁴⁺, CaAl₁₂O₁₉ :Mn⁴⁺, LaAlO₃:Mn⁴⁺, CaYAlO₄:Mn⁴⁺, CaMgSi₂O₆:Eu²⁺, Mn²⁺, and a combination of any of these.

In some embodiments of the present invention, the total amount of the phosphor of the composition is in the range from 0.01 wt. % to 30 wt. % based on the total amount of the composition, preferably it is from 0.1 wt. % to 10 wt. %, more preferably from 0.3 wt. % to 5 wt. %, furthermore preferably it is from 0.5 wt. % to 3 wt. % from the view point of better light conversion property, lower production cost and less production damage of a production machine.

### Matrix Materials

According to the present invention, in some embodiments, matrix material is an organic material, and/or an inorganic material, preferably Al₂O₃, fused composition of TeO₂:Na₂Co₃:ZnO: BaCo₃=7:1:1:1, and fused mixture of TeO₂:Na₂Co₃:ZnO:BaCo₃=7:1:1:1 and Al₂O₃ are excluded. Preferably the matrix material is an organic material.

Preferably, the matrix material is an organic oligomer or an organic polymer material, more preferably an organic polymer selected from the group consisting of a transparent photosetting polymer, a thermosetting polymer, a thermoplastic polymer, or a combination of any of these, can be used preferably.

Thus, in some embodiments of the present invention, the matrix material is an organic material, and/or an inorganic material, preferably the matrix material is an organic material, more preferably it is an organic oligomer or an organic polymer material, even more preferably an organic polymer selected from the group consisting of a transparent photosetting polymer, a thermosetting polymer, a thermoplastic polymer, or a combination of any of these.

As organic polymer materials, polysaccharides, polyethylene, polypropylene, polystyrene, polymethyl pentene, polybutene, butadiene styrene, polyvinyl chloride, polystyrene, polymethacrylic styrene, styrene-acrylonitrile, acrylonitrile-butadiene-styrene, polyethylene terephthalate, polymethyl methacrylate, polyphenylene ether, polyacrylonitrile, polyvinyl alcohol, acrylonitrile polycarbonate, polyvinylidene chloride, polycarbonate, polyamide, polyacetal, polybutylene terephthalate, polytetrafluoroethylene, ethyl vinyl acetate copolymer, ethylene tetrafluorethylen copolymer, poiyamide, phenol, melamine, urea, urethane, epoxy, unsaturated polyester, polyallyl sulfone, polyacrylate, hydroxybenzoic acid polyester, polyetherimide, polycyclohexylenedimethylene terephthalate, polyethylene naphthalate, polyester carbonate, polylactic add, phenolic resin, silicone or a combination of any of these can be used preferably.

As the photosetting polymer, several kinds of (meth)acrylates can be used preferably. Such as unsubstituted alkyl-(meth) acrylates, for examples, methyl-acrylate, methyl-methacrylate, ethyl-acrylate, ethyl-methacrylate, butyl-acrylate, butyl-methacrylate, 2-ethylhexyl-acrylate, 2-ethylhexyl-methacrylate; substituted alkyl-(meth)acrylates, for examples, hydroxyl-group, epoxy group, or halogen substituted alkyl-(meth)acrylates; cyclopentenyl(meth)acrylate, tetra-hydro furfuryl-(meth)acrylate, benzyl (meth)acrylate, polyethylene-glycol di-(meth)acrylates.

In view of better coating performance of the composition, sheet strength, and good handling, the matrix material has a weight average molecular weight in the range from 5,000 to 50,000 preferably, more preferably from 10,000 to 30,000.

According to the present invention, the molecular weight Mw is determined by means of GPO (=gel permeation chromatography) against an internal polystyrene standard.

As the thermosetting polymer, publicly known transparent thermosetting polymer can be used preferably. Such as 0E6550 (trade mark) series (Dow Corning).

As the thermoplastic polymer, the type of thermoplastic polymer is not particularly limited. For example, natural rubber(refractive index(n)=1.52), poly-isoprene(n=1.52), poly 1,2-butadine(n=1.50), polyisobutene(n=1.51), polybutene(n=1.51), poly-2-heptyl 1,3-butadine(n=1.50), poly-24-butyl-1,3-butadine(n=1.51), poly-1,3-butadine(n=1.52), polyoxyethylene(n=1.46), polyoxypropylene(n=1.45), polyvinylethyl ether(n=1.45), polyvinylhexylether(n=1.46), polyvinylbutylether(n=1.46), polyethers, poly vinyl acetate(n=1.47), poly esters, such as poly vinyl propionate(n=1.47), poly urethane(n=1.5 to 1.6), ethyl celullose(n=1.48), poly vinyl chloride(n=1.54 to 1.55), poly acrylo nitrile(n=1.52), poly methacrylonitrile(n=1.52), poly-sulfone(n=1.63), poly sulfide(n=1.60), phenoxy resin(n=1.5 to 1.6), polyethylacrylate(n=1.47), poly butyl acrylate(n=1.47), poly-2-ethylhexyl acrylate(n=1.46), poly-t-butyl acrylate(n=1.46), poly-3-ethoxypropylacrylate(n=1.47), polyoxycarbonyl tetra-methacrylate(n=1.47), polymethylacrylate(n=1.47 to 1.48), polyisopropylmethacrylate(n=1.47), polydodecyl methacrylate(n=1.47), polytetradecyl methacrylate(n=1.47), poly-n-propyl methacrylate(n=1.48), poly-3,3,5-trimethylcyclohexyl methacrylate(n=1.48), polyethylmethacrylate(n=1.49), poly-2-nitro-2-methylpropylmethacrylate(n=1.49), poly-1,1-diethylpropylmethacrylate (n=1.49), poly(meth)acrylates, such as polymethylmethacrylate(n=1.49), or a combination of any of these, can be used preferably as desired.

In some embodiments of the present invention, such thermoplastic polymers can be copolymerized if necessary.

A polymer, which can be copolymerized with the thermoplastic polymer described above is for example, urethane acrylate, epoxy acrylate, polyether acrylate, or, polyester acrylate (n=1.48 to 1.54) can also be employed. From the viewpoint of adhesiveness of the color conversion sheet, urethane acrylate, epoxy acrylate, and polyether acrylate are preferable.

According to the present invention, elastomers are incorporated into either thermoplastic polymer or thermosetting polymer based on their physical properties.

The matrix materials and the inorganic phosphors mentioned above in Matrix materials, and in—Inorganic phosphors, can be preferably used for a fabrication of the light converting medium (100),

In some embodiments of the present invention, the composition can optionally further comprise one or more of additional inorganic phosphors, which emits blue or red light,

### Additives

The composition and/or the light converting medium according to the present invention can further comprise one or more of additives. Comprising a spreading agent and/or a surface treatment agent is one preferable embodiment.

When the composition applied onto the leaves, the composition had better to remain on the leaves for some period to exhibit its property. But wax secreted by leaves can inhibit this composition remained on leaves, and drop off it from the leaves. A spreading agent functions improving spreading performances, wettability, and/or adhesion of the composition. A surface treatment agent can change the polarity of the phosphor or leave surface (preferably the phosphor) to decrease repulsive force between them. Preferably a spreading agent can be selected from the group consisting of isopropyl myristate, isopropyl palmitate, caprylic/capric acid esters of saturated C₁₂₋₁₈ fatty alcohols, oleic acid, oleyl ester, ethyl oleate, triglycerides, silicone oils, dipropylene glycol methyl ether, and combination thereof. One preferred embodiment of a spreading agent is Approach BI (Trade mark, Kao Corp.).

As one embodiment, the weight ratio of the spreading agent to the weight of the light modulating material such as phosphor, in the composition is 5-200 wt. %, preferably 5-100 wt. %, more preferably 5-20 wt. %, and furthermore preferably 7.5-15 wt. %. As one embodiment, the mass ratio of the surface treatment agent to the mass of the phosphor in the composition is 5-200 wt. %, preferably 5-100 wt. %, more preferably 5-20 wt. %, and furthermore preferably 7.5-15 wt. %.

The composition can further comprise an ingredient(s). Preferable embodiments of the ingredient are an adjuvant, a dispersant, a surfactant, a fungicide, a pesticide, a fertilizer, an antimicrobial agent, and/or an antifungal agent. An adjuvant can enhance permeability of effective component (e.g. insecticide), inhibit precipitation of solute in the composition, or decrease a phytotoxicity. The solutes (e.g. the phosphors) in the composition are not necessarily dissolved in the composition. In the case the composition is liquid, a dispersant is useful because it helps the solutes to be applied uniformly to at least one portion of a plant (preferably to the surface of the plant leaves). In here, a surfactant means it does not comprise or is not comprised by other additives, for example a spreading agent, a surface treatment agent and an adjuvant. In the case the composition is liquid, a phosphor with good suspensibility is desirable because the phosphor is easily suspended in the composition.

Preferably an adjuvant can be selected from the group consisting of a mineral oil, an oil of vegetable or animal origin, alkyl esters of such oils or mixtures of such oils and oil derivatives, and combination thereof.

Preferred embodiments of the surfactant are polyoxyethylene alkyl ethers (e.g., polyoxyethylene lauryl ether, polyoxyethylene oleyl ether and polyoxyethylene cetyl ether); polyoxyethylene fatty acid diethers; polyoxyethylene fatty acid monoethers; polyoxyethylene-polyoxypropylene block polymer; acetylene alcohol; acetylene glycol derivatives (e.g., acetylene glycol, polyethoxyate of acetylene alcohol, and polyethoxyate of acetylene glycol); silicon-containing surfactants (e.g., Fluorad (Trademark, Sumitomo 3M Ltd), MEGAFAC (Trademark, DIC Corp.), and Surufuron (Trademark, Asahi Glass Co., Ltd.)); and organic siloxane surfactants, such as, KP341 (Trademark, Shin-Etsu Chemical Co., Ltd.).

Examples of the above acetylene glycols include: 3-methyl-1-butyne-3-ol, 3-methyl-1-pentyne-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-hexyne-2,5-diol, and 2,5-dimethyl-2,5-hexanediol.

Examples of anionic surfactants include: ammonium salts and organic amine salts of alkyldiphenylether disulfonic acids, ammonium salts and organic amine salts of alkyldiphenylether sulfonic acids, ammonium salts and organic amine salts of alkylbenzenesulfonic acids, ammonium salts and organic amine salts of polyoxyethylenealkylether sulfuric acids, and ammonium salts and organic amine salts of alkyl-sulfuric acids. Further, examples of the amphoteric surfactants include 2-alkyl-N-carboxymethyl-N-hydroxyethyl imidazolium betaine, and laurylic acid amidopropyl hydroxy sulfone betaine.

Explanations of a pesticide and a fertilizer are described in later. Here, an active ingredient of pesticide formulation is a pesticide ingredient. And here, an active ingredient of fertilizer formulation is a fertilizer ingredient.

As one embodiment, the weight ratio of each 1 additive of dispersant, surfactant, fungicide, a pesticide, a fertilizer, antimicrobial agent and antifungal agent, to the weight of the phosphor in the composition is 5-200 wt. %, preferably 5-200 wt. %, more preferably 5-150 wt. %, further preferably 5-20 wt. %, and furthermore preferably 7.5-15 wt. %.

### Solvent

The composition can further comprise at least one solvent which comprises at least one selected from the group of water and organic solvent. Known usual water can be used as said water, which can be selected from agricultural water, tap-water, industrial water, pure water, distilled water and deionized water. Including said organic solvent in the composition is useful for dissolving the solute. The organic solvent is preferably selected from alcohol solvent, ether solvent and mixture thereof. One preferable embodiment of said alcohol solvent is selected from ethanol, isopropanol, cyclohexanol, phenoxyethanol, benzyl alcohol or mixture thereof. More preferable embodiment of said alcohol solvent is ethanol. One preferable embodiment of said ether solvent is selected from dimethyl ether, propyl cellosolve, butyl cellosolve, phenyl cellosolve, propylene glycol monomethyl ether, propylene glycol monoethyl ether, propylene glycol monopropyl ether, propylene glycol monobutyl ether, propylene glycol monophenyl ether or mixture thereof. More preferable embodiment of said ether solvent is dimethyl ether.

The weight ratio of said solvent(s) in the composition, to the total amount of the composition is preferably in the range from 70 to 99.95 wt. %, more preferably from 80 to 99.90 wt. %, further preferably from 90 to 99.90 wt. %, furthermore preferably from 95 to 99.50 wt. %. One embodiment of the wait ratio of said water to the sum of other solvents is preferably from 80 to 100 wt. %, more preferably from 90 to 100 wt. %, further preferably from 95 to 100 wt. %, furthermore preferably from 99 to 100 wt. %. The said solvent is preferably water, ethanol, dimethyl ether or mixture thereof. The solvent consisting of water is one preferred embodiment to avoid unnecessary effect for animals.

The weight ratio of the phosphor(s) to the total weight of the composition is preferably in the range from 0.05 to 30 wt. %, more preferably from 0.1 to 10 wt. %, further preferably from 0.5 to 5 wt. %, furthermore preferably from 0.8 to 3 wt. %. In the case the composition is liquid, the applied amount of the phosphor(s) on a plant (preferably leaves) depends on the phosphor's concentration and the composition's dose to be applied. The skilled person can control them based on an applied measure, a purpose, plant species, and so on. Of course, the sum of the mass ratio of said solvent and the mass ratio of the phosphor(s) to the total mass of the composition doesn't exceed 100 wt. %.

The mol/L of the phosphor(s) in the composition is preferably in the range from 10⁻⁷ to 10⁻² mol/L, more preferably from 10⁻⁶ to 10⁻³ mol/L, further preferably from 10⁻⁵ to 10⁻⁴ mol/L. In the case the phosphor has variety range of its molecular weight, known methods to get an average molecular weight (preferably a weight average molecular weight) can be used to calculate its mol/L (molar concentration).

### Light Converting Medium

In another aspect, the present invention further relates to a light converting medium comprising at least one light modulating material and a matrix material, preferably the light converting medium contains at least one attaching part so that the light converting medium can be attached to at least a part of a plant. Preferably said light converting part comprises a plurality of light modulating materials.

The light converting medium of the present invention is suitable for use in agriculture for controlling a condition of a plant. Especially it is suitable for the method of the present invention to irradiate at least a part of the underside surface of a leaf of a plant.

According to the present invention, said light converting medium can be easily attached and also it can be easily removed. And one or more of said light converting mediums can be attached on the same plant or more than two plants to irradiate the underside surface of that plants effectively.

In some embodiments of the present invention, said light converting medium can comprise a light converting part and at least one attaching part, wherein said light converting part comprises at least one light modulating material and a matrix material, preferably said light converting part comprises a plurality of light modulating materials.

In a preferred embodiment of the present invention, said light converting medium comprise at least a light converting part and said light converting part comprises one or more slits like described in FIG. 1.

In some preferred embodiments of the present invention, said one or more slits can be used to place the light converting medium underside of a leaf by catching one or more slits on a leaf or stem of a plant.

In a preferred embodiment of the present invention, said light converting medium is in a form of net or sheet.

Preferably, the thickness of the light converting medium is in the range from 1 μm to 1,000 μm, preferably it is in the range from 5 μm to 500 μm, even more preferably it is in the range from 10 μm to 250 μm.

In some embodiments of the present invention, the total amount of the phosphor in the a light converting part is in the range from 0.01 wt. % to 50 wt. % based on the total amount of the matrix material, preferably it is from 0.1 wt. % to 20 wt. %, more preferably from 0.3 wt. % to 10 wt. %, furthermore preferably it is from 0.5 wt. % to 5 wt. % from the view point of better light conversion property, lower production cost and less production damage of a production machine.

### PREFERABLE EMBODIMENTS

1. Method for controlling a condition of a plant comprising at least;
i) irradiating at least a part of an underside of a leaf of a plant with a light emitted from an artificial light source and/or with light emitted from a light modulating material and/or with light selectively reflected from a light modulating material.

2. The method of embodiment 1, wherein the step (i) comprises at least the following steps ii) and iii);
ii) absorbing at least a part of light that passed through a leaf of a plant with at least one light modulating material, a composition comprising at least one light modulating material and/or a light converting medium comprising at least one light modulating material,
wherein said at least one light modulating material, a composition comprising at least one light modulating material and/or a light converting medium comprising at least one light modulating material, is placed at least a part of the underside of a leaf;
iii) irradiating at least a part of the underside surface of a leaf of a plant with light emitted and/or with light selectively reflected from the light modulating material.

3. Method of embodiment 1 or 2, wherein the light emitted from or selectively reflected from the light modulating material has the peak maximum light wavelength in the range of 500 nm or less, and/or 600nm or more, preferably it is in the range from 400 to 500 nm and/or from 600 to 750 nm.

4. Method of any one of embodiments 1 to 3, wherein step i), preferably in step ii) and/or step iii), the light modulating material, the composition and/or the light converting medium is placed directly onto the underside surface of a leaf of a plant or within 15 cm from the underside surface of a leaf of a plant, preferably the distance between the underside surface of a leaf of a plant and the light modulating material is in the range from 0 cm to 15 cm, more preferably 0.01 cm to 15 cm, even more preferably from 0.1 cm to 10 cm, even more preferably in the range from 0.1 cm to 5 cm.

5. Method of any one of embodiments 1 to 4, wherein the light modulating material and/or the light converting medium is coated by an adhesive material.

6. Method of any one of embodiments 1 to 5, wherein the composition further comprises an adhesive material.

7. Method of any one of embodiments 1 to 6, wherein the light converting medium contains at least one attaching part so that the light converting medium can be attached to a part of a plant.

8. Method of any one of embodiments 1 to 7, wherein the light converting medium is in a form of net or sheet.

9. Method of any one of embodiments 1 to 8, wherein the thickness of the light converting medium is in the range from 1 μm to 1,000 μm, preferably it is in the range from 5 μm to 500 μm, even more preferably it is in the range from 10 μm to 250 μm.

10. Method of any one of embodiments 1 to 9, wherein the light modulating material is selected from pigments, dyes and luminescent materials, preferably the light modulating material is a luminescent material, more preferably the light modulating material a luminescent material selected from organic materials or inorganic materials , even more preferably the light modulating material is an inorganic material selected from phosphors or semiconductor nanoparticles.

11. Method of any one of embodiments 1 to 10, wherein the light modulating material is a phosphor based on garnet, silicate, orthosilicate, thiogallate, sulfide, nitride, silicon-based oxynitride, nitridosilicate, nitridoaluminumsilicate, oxonitridosilicate, oxonitridoaluminumsilicate or rare earth doped sialon.

12. The method of any one of embodiments 1 to 11, wherein said light modulating material is a metal oxide phosphor represented by following formula (I),

C1ₚC2_{q}C3rC4ₛOₜ:MC (I)

wherein C1 is a monovalent cation which is at least one selected from the group consisting of Li, Na, K, Rb and Cs,
C2 is a divalent cation which is at least one selected from the group consisting of Mg, Zn, Cu, Co, Ni, Fe, Ca, Sr, Ba, Mn, Ce and Sn,
C3 is a trivalent cation which is at least one selected from the group consisting of Y, Gd, Lu, Ce, La, Tb, Sc, Sm, Al, Ga, and In,
C4 is a tetravalent cation which is at least one selected from the group consisting of Si, Ti, and Ge,
MC is a metal cation which is at least one selected from the group consisting of Cr³⁺, Eu²⁺, Mn²⁺, Mn⁴⁺, Fe³⁺, and Ce³⁺, and
p, q, r, s and t are integers on or more than 0, satisfying that (1p+2q+3r+4s)=2t, and at least one of p, q, r and s is on or more than 1.

13. The method of any one of embodiments 1 to 12, wherein said light modulating material is a metal oxide phosphor selected from the group consisting of Cr activated metal oxide phosphors represented by following formulae (II) or (III), Mn activated metal oxide phosphors represented by following formulae (IV) or (V), and metal oxide phosphors represented by following formulae (I′) to (X′) or (VII″);

AₓB_{y}O_{z}:Cr³⁺ (II)

wherein A is a trivalent cation and is selected from the group consisting of Y, Gd, Lu, Ce, La, Tb, Sc, and Sm, B is a trivalent cation and is selected from the group consisting of Al, Ga, Lu, Sc, and In; x and y are integers; x≥0; y≥1; and 1.5(x+y)=z;

XₐZ_{b}O_{c}:Cr³⁺ (III)

wherein X is a divalent cation and is selected from the group consisting of Mg, Zn, Cu, Co, Ni, Fe, Ca, Sr, Ba, Mn, Ce and Sn; Z is a trivalent cation and is selected from the group consisting of Al, Ga, Lu, Sc and In; a and b are integers; b≥0; a≥1; and (a+1.5b)=c;

C2_{q}C3ᵣC4ₛOₜ:MC²⁺ (IV)

wherein MC²⁺ is a divalent metal cation selected from “Eu²⁺”, “Mn²⁺”, or “Eu²⁺, Mn²⁺”;
the definitions of C2, C3, C4, q, r, s and t are independently same to claim 11;

C2_{q}C3ᵣC4ₛOₜ:Mn⁴⁺ (V)

wherein the definitions of C2, C3, C4, q, r, s and t are independently same to claim 11;

AₓB_{y}O_{z}:Mn⁴⁺ (I′)

wherein A is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺, B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺ or a combination of Ti³⁺ and Zr³⁺, x is 2, y is 1, z is 4;

XₐZ_{b}O_{c}:Mn⁴⁺ (II′)

wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li⁺, Na⁺ or a combination of these, Z is Ti³⁺, Zr³⁺ or a combination of these a is 2, b is 1, c is 3;

D_{d}EₑO_{f}:Mn⁴⁺ (III′)

wherein D is a divalent cation and is selected from one or more members of the group consisting of Mg²⁺, Zn²⁺, Cu²⁺, Co²⁺, Ni²⁺, Fe²⁺, Ca²⁺, Sr²⁺, Ba²⁺, Mn²⁺, Ce²⁺ and Sn²⁺; E is a trivalent cation and is selected from the group consisting of Al³⁺, Ga³⁺, Lu³⁺, Sc³⁺, La³⁺ and In³⁺; e≥10; d≥0; (d+1.5e)=f, preferably D is Ca²⁺, Sr²⁺, Ba²⁺ or a combination of any of these, E is Al³⁺, Gd³⁺ or a combination of these, d is 1, e is 12, f is 19;

D_{g}EₕOᵢ:Mn⁴⁺ (IV′)

wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5g+1.5h)=I, preferably D is La³⁺, E is Al³⁺, Gd³⁺ or a combination of these, g is 1, h is 12, i is 19;

GⱼJₖLₗOₘ:Mn⁴⁺ (V′)

wherein G is a divalent cation and is selected from one or more members of the group consisting of Mg²⁺, Zn₂₊, Cu₂₊, Co²⁺, Ni²⁺, Fe²⁺, Ca²⁺, Sr²⁺, Ba²⁺, Mn²⁺, Ce²⁺ and Sn²⁺; J is a trivalent cation and is selected from the group consisting of Y³⁺, Al³⁺, Ga³⁺, Lu³⁺, Sc³⁺, La³⁺ and In³⁺; L is a trivalent cation and is selected from the group consisting of Al³⁺, Ga³⁺, Lu³⁺, Sc³⁺, La³⁺ and In³⁺; l≥0; k≥0; j≥0; (j+1.5k+1.51)=m, preferably G is selected from Ca²⁺, Sr²⁺, Ba²⁺ or a combination of any of these, J is Y³⁺, Lu³⁺ or a combination of these, L is Al³⁺, Gd³⁺ or a combination of these, j is 1, k is 1,1 is 1, m is 4;

MₙQₒRₚO_{q}:Eu, Mn (VI′)

wherein M and Q are divalent cations and are, independently or dependently of each other, selected from one or more members of the group consisting of Mg²⁺, Zn²⁺, Cu²⁺, Ni²⁺, Fe²⁺, Ca²⁺, Sr²⁺, Ba²⁺, Mn²⁺, Ce²⁺ and Sn²⁺; R is Ge³⁺, Si³⁺, or a combination of these; n≥1; o≥0; p≥1; (n+o+2.0p)=q, preferably M is Ca²⁺, Sr²⁺, Ba²⁺ or a combination of any of these, Q is Mg²⁺, Ca²⁺, Sr²⁺, Ba²⁺, Zn²⁺ or a combination of any of these, R is Ge³⁺, Si³⁺, or a combination of these, n is 1, o is 1, p is 2, q is 6;

A₅P₆O₂₅:Mn⁴⁺ (VII′)

wherein the component “A” stands for at least one cation selected from the group consisting of Si⁴⁺, Ge⁴⁺, Sn⁴⁺, Ti⁴⁺ and Zr⁴⁺;

(A₁₋ₓMnₓ)₅P₆O₂₅ (VII″)

The component A stands for at least one cation selected from the group consisting of Si⁴⁺, Ge⁴⁺, Sn⁴⁺, Ti⁴⁺ and Zr⁴⁺, preferably A is Si⁴⁺; 0<x≤0.5, preferably 0.05<x≤0.4. As a preferred embodiment of the present invention, Mn of formula (VII″) is Mn4⁺;

XO₆ (VIII′)

wherein X=(A¹)₂B¹(C¹₍₁₋ₓ₎Mn⁴⁺_{5/4x}), or X=A²B²C²(D¹_{(1-y)}Mn⁴⁺_{1.50y}), 0<x≤0.5, 0<y≤0.5,
A¹, B¹, C¹, A², B², C² and D¹ are independently same to below;

A¹₂B¹C¹O₆:Mn⁴⁺ (IX′)

A¹=at least one cation selected from the group consisting of Mg²⁺, Ca²⁺, Sr²⁺ and Ba²⁺Zn²⁺, preferably A¹ is Ba²⁺,
B¹=at least one cation selected from the group consisting of Sc³⁺, Y³⁺, La³⁺, Ce³⁺, B³⁺, Al³⁺ and Ga³⁺, preferably B¹ is Y³⁺,
C¹=at least one cation selected from the group consisting of V⁵⁺, Nb⁵⁺ and Ta⁵⁺, preferably C¹ is Ta⁵⁺;

A²B²C²D¹O₆:Mn⁴⁺ (X′)

A²=at least one cation selected from the group consisting of Li⁺, Na⁺, K⁺, Rb⁺ and Cs⁺, preferably A² is Na⁺,
B²=at least one cation selected from the group consisting of Sc³⁺, La³⁺, Ce³⁺, B³⁺, Al³⁺ and Ga³⁺, preferably B² is La³⁺,
C²=at least one cation selected from the group consisting of Mg²⁺, Ca²⁺, Sr²⁺, Ba²⁺ and Zn²⁺, preferably C² is Mg²⁺,
D¹=at least one cation selected from the group consisting of Mo⁶⁺ and W⁶⁺, preferably D¹ is W⁶⁺.

14. The method of any one of embodiments 1 to 13, wherein said light modulating material is a metal oxide phosphor selected from the group consisting of Al₂O₃:Cr³⁺, Y₃Al₅O₁₂:Cr³⁺, MgO:Cr³⁺, ZnGa₂O₄:Cr³⁺, MgAl₂O₄:Cr³⁺, Sr₃MgSi₂O₈:Mn⁴⁺, Sr₂MgSi₂O₇:Mn⁴⁺, SrMgSi₂O₆:Mn⁴⁺, Mg₂SiO₄:Mn²⁺, BaMg₆Ti₆O₁₉:Mn⁴⁺, Mg₂TiO₄:Mn⁴⁺, Li₂TiO₃:Mn⁴⁺, CaAl₁₂O₁₉:Mn⁴⁺, ZnAl₂O₄:Mn²⁺, LiAlO₂:Fe³⁺, LiAl₅O₈:Fe³⁺, NaAlSiO₄:Fe³⁺, MgO:Fe³⁺, Mg₈Ge₂O₁₁F₂:Mn⁴⁺, CaGa₂S₄:Mn²⁺, Gd₃Ga₅O₁₂:Cr³⁺, Gd₃Ga₅O₁₂:Cr³⁺, Ce³⁺, (Ca,Ba,Sr)MgSi₂O₆:Eu, Mn, (Ca,Ba,Sr)₂MgSi₂O₇:Eu, Mn, (Ca,Ba,Sr)₃MgSi₂O₈:Eu, Mn, ZnS, InP/ZnS, CuInS₂, CuInSe₂, CuInS₂/ZnS, carbon quantum dot, CaMgSi₂O₆:Eu²⁺, Mn2⁺, Si₅P₆O₂₅:Mn⁴⁺ , Ba₂YTaO₆:Mn⁴⁺, NaLaMgWO₆:Mn⁴⁺, Y₂MgTiO₆:Mn⁴⁺, CaMgSi₂O₆:Eu²⁺, Sr₂MgSi₂O₇:Eu²⁺, SrBaMgSi₂O₇:Eu²⁺, Ba₃MgSi₂O₈:Eu²⁺, LiSrPO₄:Eu²⁺, LiCaPO₄:Eu2+, NaSrPO₄:Eu²⁺, KBaPO₄:Eu²⁺, KSrPO₄:Eu²⁺, KMgPO₄:Eu²⁺, —Sr₂P₂O₇:Eu²⁺, —Ca₂P₂O₇:Eu²⁺, Mg₃(PO₄)₂:Eu²⁺, Mg₃Ca₃(PO₄)₄:Eu²⁺, BaMgAl₁₀O₁₇:Eu2+, SrMgAl₁₀O₁₇:Eu²⁺, AlN:Eu²⁺, Sr₅(PO₄)₃Cl:Eu²⁺, NaMgPO₄ (glaserite):Eu²⁺, Na₃Sc₂(PO₄)₃:Eu²⁺, LiBaBO₃:Eu²⁺, NaSrBO₃:Ce³⁺, NaCaBO₃:Ce³⁺, Ca₃(BO₃)₂:Ce³⁺, Sr₃(BO₃)₂:Ce³⁺, Ca₃Y(GaO)₃(BO₃)₄:Ce³⁺, Ba₃Y(BO₃)₃:Ce³⁺, CaYAlO₄:Ce³⁺, Y₂SiO₅:Ce³⁺, YSiO₂N:Ce³⁺, Y₅(SiO₄)₃N:Ce³⁺, CaAlSiN₃:Eu²⁺, SrAlSiN₃:Eu²⁺, Sr₂Si₅N₈:Eu²⁺, SrLiAlN₄:Eu²⁺, LiAl₅O₈:Cr³⁺, SrAlSi₄N₇:Eu²⁺, Ca₂SiO₄:Eu²⁺, NaMgPO₄:Eu²⁺, CaS:Eu²⁺, K₂SiF₆:Mn⁴⁺, K₃SiF₇:Mn⁴⁺, K₂TiF₆:Mn⁴⁺, K₂NaAlF₆:Mn⁴⁺, BaSiF₆:Mn⁴⁺, YVO₄:Eu³⁺, MgSr₃Si₂O₈:Eu²⁺, Mn²⁺, Y₂O₃:Eu³⁺, Ca₂Al₃O₆FGd₃Ga₅O₁₂:Cr³⁺, Ce³⁺ and graphene quantum dot.

15. A plant obtained or obtainable from the method of any one of embodiments 1 to 14.

16. Use of a light modulating material, a composition comprising at least one light modulating material and another material, or a formulation comprising at least a composition and a solvent, for controlling a condition of a plant by providing said light modulating material, said composition, or said formulation onto at least a part of an underside of a leaf of a plant.

17. Use of an optical medium comprising at least one light modulating material and/or a composition comprising at least one light modulating material and another material, for controlling a condition of a plant by providing the optical medium so that the emitted light from the optical medium can irradiate at least a part of underside of a leaf of a plant, preferably whole part of underside of a leaf of a plant, preferably said light converting medium comprises a plurality of light modulating materials.

18. A light converting medium comprising at least one light modulating material and a matrix material and/or a composition comprising at least one light modulating material and another material, wherein the light converting medium contains at least one attaching part so that the light converting medium can be attached to at least a part of a plant, preferably said light converting medium comprises a plurality of light modulating materials.

19. Use of an light converting medium comprising at least one light modulating material and/or a composition comprising at least one light modulating material and another material, for controlling a condition of a plant by placing the light converting medium so that the emitted light from the light converting medium can irradiate at least a part of underside of a leaf of a plant, preferably whole part of underside of a leaf of a plant, preferably said light converting medium comprises a plurality of light modulating materials.

### Effect of the Invention

The present invention provides one or more of technical effects as listed below; realizing improved irradiation/reflection amount from the light source to the leaf surface;

use of light emitted from the light source more efficiently; preventing or reducing damping of the converted light emitted/reflected from the light converting material; providing the optimal structure for acquiring the functional wavelengths for plants more efficiently and/or more easily; providing highly practical plant growing materials and installation methods for generating light with enhanced blue, red and/or infrared light color components; providing the materials' optical function to the plants for a longer time period; setting of the agricultural materials without requiring hard labor; setting of the agricultural materials without paying high material costs; providing the agricultural materials capable of having two or more effects.

The synthesis examples and working examples below provide descriptions of the present inventions but not intended to limit scopes of the inventions.

### WORKING EXAMPLES

### Working Example 1

In a typical synthesis of Y₂MgTiO₆:Mn⁴⁺, the phosphors precursors are synthesized by a conventional polymerized complex method. The raw materials of yttrium oxide, magnesium oxide, titanium oxide and manganese oxide are prepared with a stoichiometric molar ratio of 2.000:1.000: 0.999:0.001. The chemicals are put in a mortar and mixed by a pestle for 30 minutes. The resultant materials are oxidized by firing at 1500° C. for 6 h in air.

To confirm the structure of the resultant materials, XRD measurements are performed using an X-ray diffractometer (RIGAKU RAD-RC). Photoluminescence (PL) spectra are measured using a spectrofluorometer (JASCO FP-6500) at room temperature.

The agricultural solution is prepared using fluorescent materials, a spreading agent, and a solvent. Then, we prepared the 1 wt % Y₂MgTiO₆:Mn⁴⁺phosphors aqueous solutions.

These experiments are conducted in a greenhouse under natural light (sun light). Agriculture composition is painted on the Radish seedlings approximately uniformly with brush on the back side of the leaves at 1st day, 15th and 28th day from planting date.

On the other hand, as a control experiment, the agriculture composition as the same of above solution is painted on the Radish seedlings approximately uniformly with brush on the front side of the leaves, and at 1st day, 15th and 28th day from planting date.

Moreover, as another control experiment, the agriculture composition without phosphors is painted on the Radish seedlings approximately uniformly with brush on the back side of the leaves, and at 1st day, 15th and 28th day from planting date.

Stems weights at 36th days from planting date are evaluated as below. Fresh stems weight of 1 plant is weighted. Stems are dried in a desiccator at 85° C. for more than 24 h. Then dried Stems weight of 1 plant is weighted. Average of 6 plants is described in below Table 1. Same procedures are done to evaluate the comparative examples, which are with phosphor on the leaves, and without phosphor on the leaves. Table 1 shows the test results.

TABLE 1

| | Working | Comparative | |
|---|---|---|---|
| | example | example 1 | Comparative |
| | (w/phosphor | (w/phosphor | example 2 |
| | behind leaves) | on leaves) | (w/o phosphor) |
| Fresh weight (g) | 7.24 | 6.74 | 5.93 |
| Dried weight (g) | 0.51 | 0.48 | 0.39 |

This test showed that the working example plants grew more than the comparative example ones.

### Working Example 2

In a typical synthesis of Al₂O₃:Cr³⁺, the phosphors are synthesized by a conventional solid phase method. The raw materials of aluminum oxide and chromium oxide are prepared with a stoichiometric molar ratio of 0.99:0.01. The chemicals are put in a mortar and mixed by a pestle for 30 minutes. The resultant materials are oxidized by firing at 1400° C. for 6 h in air.

To confirm the structure of the resultant materials, XRD measurements are performed using an X-ray diffractometer (RIGAKU RAD-RC). Photoluminescence (PL) spectra are measured using a spectrofluorometer (JASCO FP-6500) at room temperature.

The agricultural solution is prepared using fluorescent materials, a spreading agent, and a solvent. Then, we prepared the 1 wt % Al₂O₃:Cr³⁺, phosphors aqueous solutions.

These experiments are conducted in a greenhouse under artificial light. Agriculture composition is painted on the Rucola seedlings approximately uniformly with brush on the back side of the leaves at 1st day and 15th day from planting date.

On the other hand, as a control experiment, the agriculture composition as the same of above solution is painted on the Rucola seedlings approximately uniformly with brush on the front side of the leaves, and at 1st day and 15th day from planting date.

Moreover, as another control experiment, the agriculture composition without phosphors is painted on the Rucola seedlings approximately uniformly with brush on the back side of the leaves, and at 1st day and 15th day from planting date.

Leaves weights at 22^{nd} days from planting date are evaluated as below. Fresh leaves weight of 1 plant is weighted. Leaves are dried in a desiccator at 85° C. for more than 24 h. Then dried Leaves weight of 1 plant is weighted. Average of 6 plants is described in below Table 2. Same procedures are done to evaluate the comparative examples 3 and 4, which are with phosphor on the leaves, and without phosphor on the leaves. Table 2 shows the test results.

TABLE 2

| | Working | Comparative | |
|---|---|---|---|
| | example 2 | example 3 | Comparative |
| | (w/phosphor | (w/phosphor | example 4 |
| | behind leaves) | on leaves) | (w/o phosphor) |
| Fresh weight (g) | 20.59 | 19.5 | 17.95 |
| Dried weight (g) | 2.13 | 1.93 | 1.61 |

This test showed that the working example plants grew more than the comparative examples 3 and 4.

### Working Example 3

In a typical synthesis of Mg₂TiO₄:Mn⁴⁺, the phosphor precursors of Mg₂TiO₄:Mn⁴⁺are synthesized by a conventional solid state reaction. The raw materials of magnesium oxide, titanium oxide and manganese oxide are prepared with a stoichiometric molar ratio of 2.000:0.999:0.001. The chemicals are put in a mixer and mixed by a pestle for 30 minutes. The resultant materials are oxidized by firing at 1000° C. for 3 hours in air.

To confirm the structure of the resultant materials, XRD measurements are performed using an X-ray diffractometer (RIGAKU RAD-RC). Photoluminescence (PL) spectra is measured by using a spectrofluorometer (JASCO FP-6500) at room temperature. The photoluminescence excitation spectrum shows a UV region from 300-400 nm while the emission spectrum exhibited a deep red region from 660-750 nm.

Then, 20 g of Mg₂TiO₄:Mn⁴⁺phosphor and 0.6 g of siloxane compound (SH 1107, manufactured by Toray Dow Corning Co., Ltd.) are put in a Waring blender, and mixed at a low speed for 2 minutes. After uniformly surface-treating in this process, the resultant materials are heat-treated in an oven at 140° C. for 90 minutes.

Then, final surface treated Mg₂TiO₄:Mn⁴⁺phosphors with aligned particle sizes are acquired by shaking with a stainless screen with an opening of 63

Pm.

The agricultural material is prepared using Mg₂TiO₄:Mn⁴⁺ as a phosphor, and Petrothene180 (Trademark, Tosoh Corporation) as a polymer. 1 wt % of Mg₂TiO₄:Mn⁴⁺ phosphors in the polymer is mixed and a large plant growth-promoting medium having 50 μm layer thickness is formed by using a Kneading machine and inflation-moulding machine.

Then all sheets are placed behind Goya leaf and it is exposed to the sun light for 15 days. Finally, their fresh weights and dried weights are measured.

### Working Example 4

### Synthesis of Al₂O₃:Cr³⁺

The phosphor precursors of Al₂O₃:Cr³⁺are synthesized by a conventional co-precipitation method. The raw materials of Aluminium Nitrate

Nonahydrate and Chromium(III) nitrate nonahydrate are dissolved in deionized water with a stoichiometric molar ratio of 0.99:0.01. NH₄HCO₃ is added to the mixed chloride solution as a precipitant, and the mixture is stirred at 60° C. for 2 h. The resultant solution is dried at 95° C. for 12 h, then the preparation of the precursors is completed. The obtained precursors are oxidized by calcination at 1300° C. for 3 h in air. To confirm the structure of the resultant materials, XRD measurements are performed using an X-ray diffractometer (RIGAKU RAD-RC). Photoluminescence (PL) spectra are measured using a spectrofluorometer (JASCO FP-6500) at room temperature.

The absorption peak maximum light wavelength of Al₂O₃:Cr³⁺ is 420 nm and 560 nm, the emission peak maximum light wavelength is in the range from 690 nm to 698 nm, the full width at half maximum (hereafter “FWHM”) of the light emission from Al₂O₃:Cr³⁺is in the range from 90 nm to 120 nm.

### Composition and Color Conversion Medium Fabrication

The agricultural material is prepared using Al₂O₃:Cr³⁺as a phosphor, and Petrothene180 (Trademark, Tosoh Corporation) as a polymer.

1 wt % of Al₂O₃:Cr³⁺phosphors in the polymer is mixed and a large plant growth-promoting medium having 50 μm layer thickness is formed by using a Kneading machine and inflation-moulding machine.

Then all sheets are placed behind Goya leaf and it is exposed to the sun light for 15 days. Finally, their fresh weights and dried weights are measured.

Table 3 shows the test results.

TABLE 3

| | Control | Mg₂TiO₄:Mn⁴⁺ | Al₂O₃:Cr³⁺ |
|---|---|---|---|
| | (comparative | (working | (working |
| | example 5) | example 3) | example 4) |
| Glucose (mg/L) | 285 | 350 | 245 |
| No³⁻ (mg/L) | 27.5 | 55 | 35 |
| K⁺ (mg/L) | 6.5 | 5.95 | 7.6 |

1. Method for controlling a condition of a plant comprising at least;
i) irradiating at least a part of an underside of a leaf of a plant with a light emitted from an artificial light source and/or with light emitted from a light modulating material and/or with light selectively reflected from a light modulating material.

2. The method of claim 1, wherein the step (i) comprises at least the following steps ii) and iii);
ii) absorbing at least a part of light that passed through a leaf of a plant with at least one light modulating material, a composition comprising at least one light modulating material and/or a light converting medium comprising at least one light modulating material,
wherein said at least one light modulating material, a composition comprising at least one light modulating material and/or a light converting medium comprising at least one light modulating material, is placed at least a part of the underside of a leaf;
iii) irradiating at least a part of the underside surface of a leaf of a plant with light emitted and/or with light selectively reflected from the light modulating material.

3. The method of claim 1, wherein the light emitted from or selectively reflected from the light modulating material has the peak maximum light wavelength in the range of 500 nm or less, and/or 600nm or more.

4. The method of claim 1,
wherein in step i), light modulating material, the composition and/or the light converting medium is placed directly onto the underside surface of a leaf of a plant or within 15 cm from the underside surface of a leaf of a plant.

5. The method of claim 1,
wherein the light modulating material and/or the light converting medium is coated by an adhesive material.

6. The method of claim 1,
wherein the composition further comprises an adhesive material.

7. The method of claim 1,
wherein the light converting medium contains at least one attaching part so that the light converting medium can be attached to a part of a plant.

8. The method of claim 1,
wherein the light converting medium is in a form of net or sheet.

9. The method of claim 1,
wherein the thickness of the light converting medium is in the range from 1 μm to 1,000 μm.

10. The method of claim 1,
wherein the light modulating material is selected from pigments, dyes and luminescent materials.

11. The method of claim 1,
wherein the light modulating material is a phosphor based on garnet, silicate, orthosilicate, thiogallate, sulfide, nitride, silicon-based oxynitride, nitridosilicate, nitridoaluminumsilicate, oxonitridosilicate, oxonitridoaluminumsilicate or rare earth doped sialon.

12. The method of claim 1, wherein said light modulating material is a metal oxide phosphor selected Al₂O₃:Cr³⁺, Y₃Al₅O₁₂:Cr³⁺, MgO:Cr³⁺, ZnGa₂O₄:Cr³⁺, MgAl₂O₄:Cr³⁺, Sr₃MgSi₂O₈:Mn⁴⁺, Sr₂MgSi₂O₇:Mn⁴⁺, SrMgSi₂O₆:Mn⁴⁺, Mg₂SiO₄:Mn²⁺, BaMg₆Ti₆O₁₉:Mn⁴⁺, Mg₂TiO₄:Mn⁴⁺, Li₂TiO₃:Mn⁴⁺, CaAl₁₂O₁₉:Mn⁴⁺, ZnAl₂O₄:Mn²⁺, LiAlO₂:Fe³⁺, LiAl₅O₈:Fe³⁺, NaAlSiO₄:Fe³⁺, MgO:Fe³⁺, Mg₈Ge₂O₁₁F₂:Mn⁴⁺, CaGa₂S₄:Mn²⁺, Gd₃Ga₅O₁₂:Cr³⁺, Gd₃Ga₅O₁₂:Cr³⁺, Ce³⁺, (Ca,Ba,Sr)MgSi₂O₆:Eu, Mn, (Ca,Ba,Sr)₂MgSi₂O₇:Eu, Mn, (Ca,Ba,Sr)₃MgSi₂O₈:Eu, Mn, ZnS, InP/ZnS, CuInS₂, CuInSe₂, CuInS₂/ZnS, carbon quantum dot, CaMgSi₂O₆:Eu²⁺, Mn2⁺, Si₅P₆O₂₅:Mn⁴⁺ Ba₂YTaO₆:Mn⁴⁺, NaLaMgWO₆:Mn⁴⁺, Y₂MgTiO₆:Mn⁴⁺, CaMgSi₂O₆:Eu²⁺, Sr₂MgSi₂O₇:Eu²⁺, SrBaMgSi₂O₇:Eu²⁺, Ba₃MgSi₂O₈:Eu²⁺, LiSrPO₄:Eu²⁺, LiCaPO₄:Eu2+, NaSrPO₄:Eu²⁺, KBaPO₄:Eu²⁺, KSrPO₄:Eu²⁺, KMgPO₄:Eu²⁺, —Sr₂P₂O₇:Eu²⁺, —Ca₂P₂O₇:Eu²⁺, Mg₃(PO₄)₂:Eu²⁺, Mg₃Ca₃(PO₄)₄:Eu²⁺, BaMgAl₁₀O₁₇:Eu2+, SrMgAl₁₀O₁₇:Eu²⁺, AlN:Eu²⁺, Sr₅(PO₄)₃Cl:Eu²⁺, NaMgPO₄ (glaserite):Eu²⁺, Na₃Sc₂(PO₄)₃:Eu²⁺, LiBaBO₃:Eu²⁺, NaSrBO₃:Ce³⁺, NaCaBO₃:Ce³⁺, Ca₃(BO₃)₂:Ce³⁺, Sr₃(BO₃)₂:Ce³⁺, Ca₃Y(GaO)₃(BO₃)₄:Ce³⁺, Ba₃Y(BO₃)₃:Ce³⁺, CaYAlO₄:Ce³⁺, Y₂SiO₅:Ce³⁺, YSiO₂N:Ce³⁺, Y₅(SiO₄)₃N:Ce³⁺, CaAlSiN₃:Eu²⁺, SrAlSiN₃:Eu²⁺, Sr₂Si₅N₈:Eu²⁺, SrLiAlN₄:Eu²⁺, LiAl₅O₈:Cr³⁺, SrAlSi₄N₇:Eu²⁺, Ca₂SiO₄:Eu²⁺, NaMgPO₄:Eu²⁺, CaS:Eu²⁺, K₂SiF₆:Mn⁴⁺, K₃SiF₇:Mn⁴⁺, K₂TiF₆:Mn⁴⁺, K₂NaAlF₆:Mn⁴⁺, BaSiF₆:Mn⁴⁺, YVO₄:Eu³⁺, MgSr₃Si₂O₈:Eu²⁺, Mn²⁺, Y₂O₃:Eu³⁺, Ca₂Al₃O₆FGd₃Ga₅O₁₂:Cr³⁺, Ce³⁺ and graphene quantum dot.

13. A plant obtained or obtainable from the method of claim 1.

14. A light converting medium comprising at least one light modulating material and a matrix material, wherein the light converting medium contains at least one attaching part so that the light converting medium can be attached to at least a part of a plant.

15. A method for controlling a condition of a plant by placing a light converting medium so that the emitted light from the light converting medium can irradiate at least a part of underside of a leaf of a plant.

16. The method of claim 1, wherein the light emitted from or selectively reflected from the light modulating material has the peak maximum light wavelength in the range from 400 to 500 nm and/or from 600 to 750 nm.

17. The method of claim 1, wherein in step ii) and/or step iii), the light modulating material, the composition and/or the light converting medium is placed directly onto the underside surface of a leaf of a plant or within 15 cm from the underside surface of a leaf of a plant.

18. The method of claim 1, wherein in step i), the light modulating material, the composition and/or the light converting medium is placed 0.01 cm to 15 cm from the underside surface of a leaf of a plant.

19. The method of claim 1, wherein in step i), the light modulating material, the composition and/or the light converting medium is placed 0.01 cm to 10 cm from the underside surface of a leaf of a plant.

20. The method of claim 1, wherein the thickness of the light converting medium is in the range from 5 μm to 500 μm.
